(19) United States
(12) Patent Application Publication
(10) Pub. No.: US 2014/0151295 A1
(43) Pub. Date: Jun. 5, 2014

(54) PLANTS FOR ADVANCED TREATMENT OF WASTEWATER AND METHOD FOR TREATING WASTEWATER USING THEREOF

(71) Applicants: Lee Seock Heon, Seoul (KR); Na Yong Hun, Seoul (KR); Yang Seung Heun, Hwaseong-si (KR)

(72) Inventors: Lee Seock Heon, Seoul (KR); Na Yong Hun, Seoul (KR); Yang Seung Heun, Hwaseong-si (KR)

(73) Assignee: KOREA INSTITUTE OF SCIENCE AND TECHNOLOGY, Seoul (KR)

(21) Appl. No.: 13/755,570

(22) Filed: Jan. 31, 2013

(30) Foreign Application Priority Data
Nov. 30, 2012 (KR) 10-2012-0137499

(51) Int. Cl. C02F 9/00

(52) U.S. Cl. CPC C02F 9/00
USPC 210/609; 210/195.2

(57) ABSTRACT

The invention relates to an advanced wastewater treatment apparatus that may include a forward osmosis module, a draw-solution separation device, and an ammonia removal device. The forward osmosis module may be installed after a first settling tank, and may include an inflow-water side where water treated by the first settling tank flows, a separation membrane for allowing the treated water to pass therethrough, and a draw-solution side where the draw solution flows. The draw-solution separation device may separate the draw solution and the water of the draw solution, return the separated draw solution to the draw-solution side of the forward osmosis module, and discharge the separated water to the outside. The ammonia removal device may eliminate the ammonia from the treated water of the forward osmosis module.

### CROSS-REFERENCE TO RELATED APPLICATION

This application claims priority to and the benefit of Korean Patent Application No. 10-2012-0137499 filed in the Korean Intellectual Property Office on Nov. 30, 2012, the entire contents of which are incorporated herein by reference.

### BACKGROUND OF THE INVENTION

(a) Field of the Invention

The invention relates to an advanced treatment apparatus for treating wastewater with low energy.

(b) Description of the Related Art

Recently, in an advanced wastewater treatment of activated sludge operated in South Korea, an efficient operation of the method may be difficult and small-to-middle sized facilities may generally used because seasonal water quality variations are large and carbon/nitrogen ratio, which is a ratio of an organic material necessary to eliminate nitrogen and phosphorus, is low. Particularly, when a technique developed in a foreign country is applied in our country, technical reviews or overviews (such as changing design factors) should be sufficiently conducted in advance.

In a water treatment process for purifying wastewater or for freshening or desalting seawater, a membrane separation process using membrane filtration is recently receiving attention. The membrane separation process separates pollutants and purified water in feed water through a physical mechanism. In order to solve problems of the conventional advanced wastewater treatment process through the physical mechanism, studies for replacing solid-liquid separation using gravity settling with the membrane separation are in progress. The membrane separation may be called a membrane separation process of an activated sludge or a submerged membrane coupled activated sludge process. Also, an apparatus formed by assembling a general biological reactor and a membrane separation process is called a membrane bio-reactor (MBR).

Membrane separation processes applicable to the MBR process are classified to a filtration process, a microfiltration process, an ultrafiltration process, a nanofiltration process, and a reverse osmosis process according to a size of particles or molecules to be separated. In the membrane separation process, optimized pressure is applied to the membrane during the process.

The MBR processes may be classified into a cross-flow MBR process and a submerged MBR process according to filtration methods. The MBR processes have a lot of advantages, compared to the conventional activated sludge process. Because microbial concentration of the MBR process is three to four times the microbial concentration of the conventional activated sludge, the capacity of an aeration tank can be small and decomposition of the organic material can be effectively decomposed. Also, all suspended solids can be eliminated, and thus, the process can be stably performed regardless of sedimentation degree of the sludge. In addition, a sludge retention time (SRT) can be maximized, nitrification can be induced, and an amount of excess sludge can be reduced. Further, a settling tank is not necessary and a volume of a sludge thickener can be reduced, and thus, a size for the process can be small. Also, bacteria or virus can be eliminated.

On the other hand, the MBR processes have various disadvantages. In the cross-flow MBR process, a system is very complicate and uses high pressure, and thus, power operation cost is very high. Also, because the system uses the high pressure, a surface of the membrane may be heavily polluted, and maintenance and administration fee for cleaning and a replacing the membrane, and so on may increase. In the submerged MBR process, it is difficult to control the sludge of high concentration, and a tangle of the membrane may be induced by concomitants or contaminants such as hair. Also, in the process of a hollow-fiber type, the separation membrane and module may be damaged.

Meanwhile, studies on reclaimed water processes (or water reuse processes) are actively in progress in order to solve problems such as water shortage, rise in greenhouse gas due to energy consumption, and so on. In the reclaimed water process, sewage flowing into a sewage treatment plant is processed by various methods, and then, the processed water is used again for living or industrial use. Also, a bio gas that is a by-product generated at an anaerobic digestion process (that is one of sewage treatment processes) can be actively collected and used in order to increase energy efficiency. However, when the seasonal water quality variations are large and inflow concentration is low, efficiency is low according to the conventional process. Also, in the anaerobic digestion process, yield of the bio gas is low because the growth of anaerobes is limited due to high nitrogen concentration.

The above information disclosed in this Background section is only for enhancement of understanding of the background of the invention and therefore it may contain information that does not form the prior art that is already known in this country to a person of ordinary skill in the art.

### SUMMARY OF THE INVENTION

The invention has been made in an effort to solve problems of the conventional activated sludge treatment process and advanced wastewater treatment process, and is directed to provide an advanced wastewater treatment apparatus being able to minimize energy consumption at a separation of feed water and purified water and to minimize membrane pollution phenomenon generated by the feed water.

The invention is directed to increase efficiency of an anaerobic digester and a collect rate of bio gas in an aspect reuse of wastewater energy.

The invention relates to an advanced wastewater treatment apparatus, and more particularly, to an advanced wastewater treatment apparatus including a forward osmosis module, a draw-solution separation device, and an ammonia removal device. The forward osmosis module is installed after a first settling tank. The first settling tank performs a first sedimentation process of inflow water. In this instance, the inflow water flows into the first settling tank after passing through a grit chamber. The forward osmosis module includes an inflow-water side where first-treated water treated by the first settling tank flows from the first settling tank, a separation membrane for allowing water of the first-treated water to pass therethrough by forward osmosis induced by osmotic pressure difference, and a draw-solution side where the draw solution flows for inducing the osmotic pressure difference between the inflow-water side and the draw-solution side. The draw-solution separation device separates the draw solution and the water of the draw solution being diluted at and discharged from the draw-solution side of the forward osmosis module, supplies the separated draw solution to the draw-solution side of the forward osmosis module again, and discharges the separated water to the outside. The ammonia removal device eliminates the ammonia from the first-treated water concentrated at and discharged from the inflow-water side of the forward osmosis module.

The invention is not limited to a kind of the draw solution flowing into the draw-solution side of the forward osmosis module. Thus, various solutions for inducing the osmotic pressure higher than that of the first-treated water flowing into the inflow-water side may be used for the draw solution. For example, the draw solution may include a magnetic particle (or magnetic particles) as the draw solute. The draw solution may include at least one selected from the group consisting of sodium chloride (NaCl), sodium nitrite (NaNO₃), potassium nitrite (KNO₃), magnesium chloride (MgCl₂), calcium chloride (CaCl₂), ammonium bicarbonate ((NH₄)HCO₃), sulfur dioxide (SO₂), aliphatic alcohols, aluminum sulfate (Al₂(SO₄)₃), glucose, and fructose as the draw solute.

Various devices for separating the draw solution and the water of the diluted draw solution (that is diluted at and discharged from the draw-solution side of the forward osmosis module) may be used for the draw-solution separation device. For example, in the case that the draw solution of the forward osmosis module includes the magnetic particle as the draw solute, a magnetic separation device for inducing magnetism and separating the magnetic particle may be used for the draw-solution separation device. In the case that the draw solution of the forward osmosis module includes at least one selected from the group consisting of sodium chloride (NaCl), sodium nitrite (NaNO₃), potassium nitrite (KNO₃), magnesium chloride (MgCl₂), calcium chloride (CaCl₂), ammonium bicarbonate ((NH₄)HCO₃), sulfur dioxide (SO₂), aliphatic alcohols, aluminum sulfate (Al₂(SO₄)₃), glucose, and fructose as the draw solute, a reverse osmosis device, a membrane distillation device, a nanofiltration device, or a ultrafiltration device may be used for the draw-solution separation device.

In the invention, various ammonia removal devices for eliminating the ammonia from the first-treated water concentrated at and discharged from the inflow-water side of the forward osmosis module may be used. For example, an ammonia absorption removal device for absorbing and eliminating the ammonia in the water through using absorbents such as zeolite, and active carbon may be used for the ammonia removal device.

The advanced wastewater treatment apparatus according to the invention may further include a sludge thickener and the anaerobic digester sequentially installed after the ammonia removal device.

An advanced wastewater treatment method according to an aspect of the invention includes steps of: performing a first sedimentation process of inflow water by a first settling tank, wherein the inflow water flowing into the first sedimentation process after passing a grit chamber; treating biological oxygen demand (BOD), suspended solid (SS), nitrogen (N), phosphorus (P), colon bacterium, and dissolved pollutants of the first-treated water processed by the first settling tank by forward osmosis through a forward osmosis module installed after the first settling tank; separating the draw solution and the water of the draw solution diluted at and discharged from the draw-solution side of the forward osmosis module by the draw-solution separation device, supplying the separated draw solution to the draw-solution side of the forward osmosis module again, and discharging the separated water to the outside; eliminating an ammonia concentrated at and discharged from the first-treated water flows from the inflow-water side of the forward osmosis module by an ammonia removal device and transferring the same to a sludge thickener; and generating a bio gas by supplying the sludge concentrated at the sludge thickener to an anaerobic digester, transferring remained sludge to a dehydrator, and dehydrating the remained sludge.

According to the exemplary embodiment of the invention, it is no need to apply pressure to the separation membrane because the advanced wastewater treatment apparatus using the membrane separation process of forward osmosis uses the naturally-generated osmotic pressure, contrary to the conventional advanced wastewater treatment apparatus using the membrane separation process. Thus, the energy consumption during the process can be largely reduced. Also, a degree of contamination generated by a flow of feed water is low, and thus, the tangle of the separation membrane is not induced. Accordingly, the control of the membrane contamination is easy. Also, unlike the conventional advanced wastewater treatment apparatus using the membrane separation process, an artificial pressure is not applied in the invention. Thus, loads being applied to the membrane and a membrane module used during the process are very small. Accordingly, the damage of the membrane and the module can be largely reduced. In addition, a kind and concentration of the draw solution can be selectively used, and thus, purified water can be separated even from high-concentrated sludge.

Also, in the advanced wastewater treatment apparatus according to the invention, the ammonia amount of the sludge supplied to the anaerobic digester can be minimized by the ammonia removal device. Accordingly, the activation of anaerobes that are vulnerable to the ammonia can be maximized, and thus, digestive efficiency of the anaerobic digester can be maximized. Particularly, in the invention, since the ammonia of the concentrated sludge can be minimized, the digestive efficiency of the anaerobic digester can be enhanced. Thus, the collect rate or the recovery factor of the bio gas such as methane (CH₄) can increase.

### BRIEF DESCRIPTION OF THE DRAWINGS

FIG. 1 is a block diagram of an advanced wastewater treatment apparatus according to an embodiment of the invention.

### DETAILED DESCRIPTION OF THE EMBODIMENTS

Hereinafter, an embodiment of the invention will be described in more detail.

The invention relates to an advanced wastewater treatment apparatus, and more particularly, to an advanced wastewater treatment apparatus including a forward osmosis module, a draw-solution separation device, and an ammonia removal device. The forward osmosis module is installed after a first settling tank. The first settling tank performs a first sedimentation process of inflow water. In this instance, the inflow water flows into the first settling tank after passing through a grit chamber. The forward osmosis module includes an inflow-water side where first-treated water treated by the first settling tank flows from the first settling tank, a separation membrane for allowing water of the first-treated water to pass therethrough by forward osmosis induced by osmotic pressure difference, and a draw-solution side where the draw solution flows for inducing the osmotic pressure difference between the inflow-water side and the draw-solution side. The draw-solution separation device separates the draw solution and the water of the draw solution being diluted at and discharged from the draw-solution side of the forward osmosis module, supplies the separated draw solution to the draw-solution side of the forward osmosis module again, and discharges the separated water to the outside. The ammonia removal device eliminates the ammonia from the first-treated water concentrated at and discharged from the inflow-water side of the forward osmosis module.

In the invention, the forward osmosis module includes the inflow-water side, the separation membrane, and the draw-solution side. The inflow-water side is a space where first-treated water treated by the first settling tank flows from the first settling tank. The draw-solution side is a space of the forward osmosis module where the draw solution for inducing the osmotic pressure flows. The separation membrane is a membrane used for the water treatment system of the forward osmosis type. In the water treatment system of the forward osmosis type according to the embodiment of the invention, it is needed that the water flows from the inflow-water side to the draw-solution side through the separation membrane. Thus, a hydrophilic membrane having high permeability of water in an osmotic direction may be preferably used for the separation membrane. The separation membrane generally used for the forward osmosis module is made of a CA (cellulose acetate) membrane, and a PA (polyamide) membrane or a TFC (thin film composite) membrane. The separation membrane includes an active layer for excluding salt and a supporting layer for supporting the active layer. A separation membrane of CTA (cellulose triacetate) made by Hydration Technology Inc. (HTI) of the United States of America is a representative membrane as a commercialized separation membrane used for the forward osmosis module.

The invention is not limited to a kind of the draw solution flowing into the draw-solution side of the forward osmosis module. Thus, various solutions for inducing the osmotic pressure higher than that of the first-treated water flowing into the inflow-water side may be used for the draw solution. For example, the draw solution may include a magnetic particle (or magnetic particles) as the draw solute. The draw solution may include at least one selected from the group consisting of sodium chloride (NaCl), sodium nitrite (NaNO₃), potassium nitrite (KNO₃), magnesium chloride (MgCl₂), calcium chloride (CaCl₂), ammonium bicarbonate ((NH₄)HCO₃), sulfur dioxide (SO₂), aliphatic alcohols, aluminum sulfate (Al₂(SO₄)₃), glucose, and fructose as the draw solute. The magnetic particle according to the embodiment of the invention is a ferromagnetic particle. For the magnetic particle, an iron oxide (Fe₂O₃, Fe₃O₄), ferrite (one Fe of Fe₃O₄ is replaced with another magnetic-related element, for example, CoFe₂O₄, MnFe₂O₄, and so on), an alloy (alloying with a precious metal for preventing an oxidation of the magnetic element and for enhancing conductivity and stability, for example, FePt, CoPt, and so on), the magnetic particle of a core-shell structure that a hydrophilic material is coated on an iron oxide in order to enhance dispersibility and hydrophilicity of the magnetic particle (for example, the magnetic particle of the core-shell structure is citrate-coated Fe₃O₄), and so on may be used. A kind of the magnetic particle of the invention is not limited, and any kind magnetic particle may be used. In addition, a particle size of the magnetic particle according to the invention is not limited, and any size magnetic particle such as a magnetic nano particle having nano size or a magnetic particle having micro size may be used.

Various devices for separating the draw solution and the water of the diluted draw solution (that is diluted at and discharged from the draw-solution side of the forward osmosis module) may be used for the draw-solution separation device. For example, in the case that the draw solution of the forward osmosis module includes the magnetic particle as the draw solute, a magnetic separation device for inducing magnetism and separating the magnetic particle may be used for the draw-solution separation device. In the case that the draw solution of the forward osmosis module includes at least one selected from the group consisting of sodium chloride (NaCl), sodium nitrite (NaNO₃), potassium nitrite (KNO₃), magnesium chloride (MgCl₂), calcium chloride (CaCl₂), ammonium bicarbonate ((NH₄)HCO₃), sulfur dioxide (SO₂), aliphatic alcohols, aluminum sulfate (Al₂(SO₄)₃), glucose, and fructose as the draw solute, a reverse osmosis device, a membrane distillation device, a nanofiltration device, or a ultrafiltration device may be used for the draw-solution separation device.

In the conventional advanced wastewater treatment apparatus using an activated sludge membrane separation process or a membrane bio-reactor (MBR), energy is excessively consumed for the separation because predetermined pressure is applied during the separation. However, in the invention, the advanced wastewater treatment apparatus using the membrane separation process of forward osmosis uses the naturally-generated osmotic pressure. Thus, contrary to the conventional advanced wastewater treatment apparatus using the conventional membrane separation process, it has no need to apply pressure to the separation membrane in the invention. Thus, the energy consumption during the process can be largely reduced. Also, a degree of contamination generated by a flow of feed water (the first-treated water) is low, and thus, the tangle of the separation membrane is not induced. Accordingly, the control of the membrane contamination is easy. Also, unlike the conventional advanced wastewater treatment apparatus using the membrane separation process, an artificial pressure is not applied in the invention. Thus, loads being applied to the membrane and a membrane module used during the process are very small. Accordingly, the damage of the membrane and the module can be largely reduced. In addition, a kind and concentration of the draw solution can be selectively used, and thus, purified water can be separated even from high-concentrated sludge.

In the invention, various ammonia removal devices for eliminating the ammonia from the first-treated water concentrated at and discharged from the inflow-water side of the forward osmosis module may be used. For example, an ammonia absorption removal device for absorbing and eliminating the ammonia in the water through using absorbents such as zeolite, and active carbon may be used for the ammonia removal device. In the invention, the ammonia amount of the sludge supplied to an anaerobic digester can be minimized by the ammonia removal device. Accordingly, the activation of anaerobes that are vulnerable to the ammonia can be maximized, and thus, digestive efficiency of the anaerobic digester can be maximized.

The advanced wastewater treatment apparatus according to the invention may further include a sludge thickener and the anaerobic digester sequentially installed after the ammonia removal device. The sludge thickener concentrates the concentrated first-treated water passing through the ammonia removal device more, before the anaerobic digester installed after the sludge thickener, in order to enhance the digestive efficiency of anaerobic digester. Various sludge thickeners generally used in the advanced wastewater treatment apparatus may be used. In the invention, because the sludge is concentrated at or by the sludge thickener, concentration of organic materials that are the nourishments of the anaerobes can be high. Thus, the digestive efficiency of the anaerobic digester can be enhanced, and the digestive process can be stably performed.

Also, the anaerobic digester is a device decompounding organic materials in the concentrated sludge (flowing in the anaerobic digester after passing through the sludge thickener) into methane (CH₄) and carbon dioxide (CO₂) by anaerobes. Various anaerobic digesters generally used for the advanced wastewater treatment apparatus may be used. Particularly, in the invention, since the ammonia of the concentrated sludge can be minimized, an activation of the anaerobes can increase. Thus, the digestive efficiency of the anaerobic digester can be enhanced.

The methane (CH₄) is a bio gas generated during the treatment of the concentrated sludge through the anaerobic digester, and is collected by an additional collecting device. The methane can be used for renewable energy (such as, for a recycling energy source of the advanced wastewater treatment apparatus). Particularly, in the invention, since the ammonia of the concentrated sludge can be minimized, the digestive efficiency of the anaerobic digester can be enhanced. Thus, the collect rate or the recovery factor of the methane (CH₄) that is the bio gas can increase.

An advanced wastewater treatment method according to the invention includes steps of: performing a first sedimentation process of inflow water by a first settling tank, wherein the inflow water flowing into the first sedimentation process after passing a grit chamber; treating biological oxygen demand (BOD), suspended solid (SS), nitrogen (N), phosphorus (P), colon bacterium, and dissolved pollutants of the first-treated water processed by the first settling tank by forward osmosis through a forward osmosis module installed after the first settling tank; separating the draw solution and the water of the draw solution diluted at and discharged from the draw-solution side of the forward osmosis module by the draw-solution separation device, supplying the separated draw solution to the draw-solution side of the forward osmosis module again, and discharging the separated water to the outside; eliminating an ammonia concentrated at and discharged from the first-treated water flows from the inflow-water side of the forward osmosis module by an ammonia removal device and transferring the same to a sludge thickener; and generating a bio gas by supplying the sludge concentrated at the sludge thickener to an anaerobic digester, transferring remained sludge to a dehydrator, and dehydrating the remained sludge.

An embodiment of the invention will be described with reference to an accompanying drawing.

However, the following embodiment is an example for describing the invention, and the invention is not limited thereto.

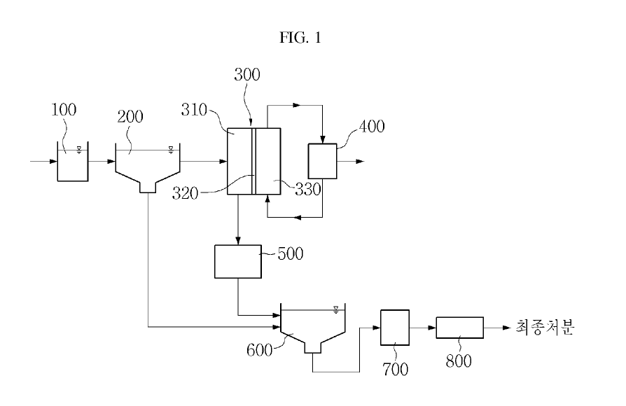

FIG. 1 is a block diagram of an advanced wastewater treatment apparatus according to an embodiment of the invention.

Referring to FIG. 1, an advanced wastewater treatment apparatus according to an embodiment of the invention includes a grit chamber 100, a first settling tank 200, a forward osmosis module 300, a draw-solution separation device 400, an ammonia absorption removal device 500, a sludge thickener 600, an anaerobic digester 700, and a dehydrator 800.

Referring to FIG. 1, inflowing wastewater firstly passes through the grit chamber 100. In the grit chamber 100, materials having relatively large volume or bulk (such as, stones or sand having large specific gravity and sinking in the water, and a plastic bottle having small specific gravity and floating on the water) are filtered out firstly.

The wastewater passing through the grit chamber 100 is transferred to the first settling tank 200. In the first settling tank 200, material (sludge) layers having specific gravity larger than that of the water and material (floating materials) having specific gravity smaller than that of the water are eliminated from the wastewater by sedimentation.

The first-treated water after passing through the first settling tank 200 is transformed to an inflow-water side 310 of the forward osmosis module 300. The water of the first-treated water transferred to the inflow-water side 310 moves through a separation membrane 320 by the osmotic pressure difference induced by the draw solution having high concentration and flowing into a draw-solution side 330 without an additional external pressure. When the water passes from the inflow-water side 310 to the draw-solution side 330 through the separation membrane 320, the draw solution of the draw-solution side 330 is diluted by the inflowing water, and the diluted draw solution is transferred to the draw-solution separation device 400. The diluted draw solution transferred to the draw-solution separation device 400 collects or reclaims the draw solution by the draw-solution separation device 400. The collected or reclaimed draw solute having a state of the concentrated draw solution is supplied to the draw-solution side 330 of the forward osmosis module 300, and the remained clean water is discharged to the outside.

Meanwhile, the concentrated first-treated water discharged from the inflow-water side 310 of the forward osmosis module 300 is transferred to an ammonia absorption removal device 500, and an ammonia (NH₃) included in the water is maximally eliminated. By sufficiently eliminating the ammonia in the concentrated first-treated water, anaerobes that are vulnerable to the ammonia can be increasingly activated, and thus, digestive efficiency of the anaerobic digester 700 can be enhanced.

The concentrated first-treated water processed by the ammonia absorption removal device 500 is transferred to the sludge thickener 600 before transferring the anaerobic digester 700. The concentrated slurry is formed in the sludge thickener 600 in order to enhance the digestive efficiency of the anaerobic digester 700. The concentrated slurry after passing through the sludge thickener 600 is transferred to the anaerobic digester 700. In the anaerobic digester 700, organic materials in the concentrated sludge are decomposed into methane (CH₄) and carbon dioxide (CO₂) by anaerobes. The generated methane (CH₄) is collected by an additional collecting device (not shown in FIG. 1) and can be used for renewable energy. The residue sludge remained in the anaerobic digester 700 is transferred to the dehydrator 800, is dehydrated, and is finally discarded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An advanced wastewater treatment apparatus, comprising:
a forward osmosis module installed after a first settling tank, wherein the first settling tank performing a first sedimentation process of inflow water, the inflow water flowing into the first settling tank after passing through a grit chamber, the forward osmosis module comprising an inflow-water side where first-treated water treated by the first settling tank flows from the first settling tank, a separation membrane for allowing water of the first-treated water to pass therethrough by forward osmosis induced by osmotic pressure difference, and a draw-solution side where the draw solution flows for inducing the osmotic pressure difference between the inflow-water side and the draw-solution side;
a draw-solution separation device for separating the draw solution and the water of the draw solution diluted at and discharged from the draw-solution side of the forward osmosis module, supplying the separated draw solution to the draw-solution side of the forward osmosis module again, and discharging the separated water to the outside; and
an ammonia removal device for eliminating ammonia from the first-treated water concentrated at and discharged from the inflow-water side of the forward osmosis module.

2. The advanced wastewater treatment apparatus according to claim 1, wherein the draw solution flowing into the draw-solution side of the forward osmosis module comprises a magnetic particle as a draw solute.

3. The advanced wastewater treatment apparatus according to claim 1, wherein the draw solution flowing into the draw-solution side of the forward osmosis module comprising at least one selected from the group consisting of sodium chloride (NaCl), sodium nitrite (NaNO₃), potassium nitrite (KNO₃), magnesium chloride (MgCl₂), calcium chloride (CaCl₂), ammonium bicarbonate ((NH₄)HCO₃), sulfur dioxide (SO₂), aliphatic alcohols, aluminum sulfate (Al₂(SO₄)₃), glucose, and fructose as the draw solute.

4. The advanced wastewater treatment apparatus according to claim 2, wherein the draw-solution separation device comprises a magnetic separation device.

5. The advanced wastewater treatment apparatus according to claim 3, wherein the draw-solution separation device comprises one selected from the group consisting of a reverse osmosis device, a membrane distillation device, a nanofiltration device, and an ultrafiltration device.

6. The advanced wastewater treatment apparatus according to claim 1, wherein the ammonia removal device comprises an ammonia absorption removal device.

7. The advanced wastewater treatment apparatus according to claim 1, further comprising a sludge thickener and an anaerobic digester sequentially installed after the ammonia removal device.

8. An advanced wastewater treatment method, comprising steps of:
performing a first sedimentation process of inflow water by a first settling tank, wherein the inflow water flowing into the first sedimentation process after passing a grit chamber;
treating biological oxygen demand (BOD), suspended solid (SS), nitrogen (N), phosphorus (P), colon bacterium, and dissolved pollutants of the first-treated water processed by the first settling tank by forward osmosis through a forward osmosis module installed after the first settling tank;
separating the draw solution and the water from the draw solution diluted at and discharged from the draw-solution side of the forward osmosis module by the draw-solution separation device, supplying the separated draw solution to the draw-solution side of the forward osmosis module again, and discharging the separated water to the outside;
eliminating an ammonia from the first-treated water concentrated at and discharged from the inflow-water side of the forward osmosis module by an ammonia removal device and transferring the same to a sludge thickener; and
generating a bio gas by supplying the sludge concentrated at the sludge thickener to an anaerobic digester, transferring remained sludge to a dehydrator, and dehydrating the remained sludge.
